(19) United States
(12) Patent Application Publication
(10) Pub. No.: US 2026/0367831 A1
(43) Pub. Date: Nov. 19, 2026

(54) Command Draining with Address Translation Service

(71) Applicant: Sandisk Technologies, Inc., Milpitas, CA (US)

(72) Inventors: Shay BENISTY, Beer Sheva (IL); Judah Gamliel HAHN, Ofra (IL)

(73) Assignee: Sandisk Technologies, Inc., Milpitas, CA (US)

(21) Appl. No.: 19/753,583

(22) Filed: Jul. 24, 2026

Related U.S. Application Data
(63) Continuation-in-part of application No. 19/085,210, filed on Mar. 20, 2025, now Pat. No. 12,717,516.
Application No. 19/085,210 is a division of application No. 18/516,219, filed on Nov. 21, 2023, now Pat. No. 12,321,633.
Application No. 18/516,219 is a division of application No. 17/714,861, filed on Apr. 6, 2022, now Pat. No. 11,861,217.
Application No. 17/714,861 is a continuation-in-part of application No. 17/184,527, filed on Feb. 24, 2021, now Pat. No. 11,500,589.
(60) Provisional application No. 63/087,737, filed on Oct. 5, 2020.

(51) Int. Cl. G06F 3/06

(52) U.S. Cl. CPC G06F 3/0656; G06F 3/0604; G06F 3/0659; G06F 3/0679

(57) ABSTRACT

A data storage device can abort a command in a storage system having address translation service (ATS). When an abort command is received after a read command has been queued for execution, the ATS cache (ATC) can be poisoned to aid in aborting the read command when the read command execution cannot be stopped. Poisoning the ATC involves finding an entry in the ATC corresponding to a virtual address for the read command. The entry includes both the virtual address and a corresponding physical address for the read command. The physical address is changed in order to poison the entry. The new physical address can be an illegal address. When the controller is notified that the address is illegal, the controller can simply ignore the notification and inform the host device that the abort command was successful.

### CROSS-REFERENCE TO RELATED APPLICATIONS

This application is a continuation-in-part of United States Patent Application Serial Number 19/085,210, filed Mar. 20, 2025, which application is a divisional of co-pending United States Patent Application Serial Number 18/516,219, filed Nov. 21, 2023, which application is a divisional of co-pending United States Patent Application Serial Number 17/714,861, filed Apr. 6, 2022, which application is a continuation-in-part of United States Patent Application Serial Number 17/184,527, filed Feb. 24, 2021, which claims benefit of United States Provisional Patent Application Serial Number 63/087,737, filed Oct. 5, 2020. Each of the aforementioned related patent applications is herein incorporated by reference.

### BACKGROUND OF THE DISCLOSURE

### Field of the Disclosure

Embodiments of the present disclosure generally relate to aborting a command efficiently.

### Description of the Related Art

In a storage system, a pending command sometimes is aborted either by the host device or by the data storage device. There are several scenarios when a command should be aborted. One scenario is where the host device issues an abort command whereby the host device specifies the ID of the command that should be aborted and the data storage device should act accordingly. A second scenario is where the host device deletes a queue command that the host device had previously issued. The host device may delete the submission or completion queue and the data storage device should then abort all associated commands before deleting the queue.

A third scenario is a command timeout where the data storage device may need to terminate the command. The termination may be due to recovery from NAND failure which involves a recovery mechanism that rebuilds data based on parity information, but the reconstruction takes a long time. The termination may also be due to maintenance starvation, which can occur due to extreme fragmentation of the physical space. Fragmentation reduces throughput which can lead to command timeouts if the commands and maintenance operations are interleaved. Interleaving of commands and maintenance generally occurs during aggressive power management where no maintenance time is permitted or during intensive high queue depth random write workloads. The termination may also be due to a very high queue depth where outstanding commands can timeout before the data storage device retrieves the commands if a command within a device is stalled due to reasons mentioned above.

A fourth scenario is advanced command retry where the data storage device decides to fail the command while asking the host device to re-queue the command at a later time. Generally, aborting a command is not a simple flow. The challenge is when the command has already started the execution phase. Before aborting the command, the data storage device must first terminate all tasks associated with the command and only then issue a completion message to the host device. After issuing the completion message, the data storage device must not access the relevant host memory buffers (HMBs).

Previously, before aborting a command, the data storage device first terminates all tasks associated with the command by scanning the pending activities and only then issuing the completion message to the host device. Alternatively, before aborting the command, the data storage device first waits until already started tasks are completed and only then will issue the completion message to the host device.

Therefore, there is a need in the art for processing abort commands more efficiently.

### SUMMARY OF THE DISCLOSURE

A data storage device can abort a command in a storage system having address translation service (ATS). When an abort command is received after a read command has been queued for execution, the ATS cache (ATC) can be poisoned to aid in aborting the read command when the read command execution cannot be stopped. Poisoning the ATC involves finding an entry in the ATC corresponding to a virtual address for the read command. The entry includes both the virtual address and a corresponding physical address for the read command. The physical address is changed in order to poison the entry. The new physical address can be an illegal address. When the controller is notified that the address is illegal, the controller can simply ignore the notification and inform the host device that the abort command was successful.

In one embodiment, a data storage device comprises: one or more memory devices; and a controller coupled to the one or more memory devices, wherein the controller is configured to: receive a command from a host device, wherein the command has a virtual address, wherein the controller maintains an ATC, and wherein the ATC contains an entry for the virtual address; receive an abort command for the command; poison the ATC; execute the command; and inform the host device that the abort command completed.

In another embodiment, a data storage device comprises: one or more memory devices; and a controller coupled to the one or more memory devices, wherein the controller is configured to: poison an ATC in response to receiving an abort command; and inform a host device that the abort command completed.

In another embodiment, a data storage device comprises: one or more memory means; and a controller coupled to the one or more memory means, wherein the controller is configured to: receive a command from a host device, wherein the command has a virtual address, wherein the controller maintains an ATC, and wherein the ATC contains an entry for the virtual address; receive an abort command for the command; change a physical address of the entry to an illegal address; receive a notification that the physical address is the illegal address; and erase the entry from the ATC.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIGS. 1A and 1B are schematic block diagrams illustrating a storage system in which data storage device may function as a storage device for a host device, according to certain embodiments.

FIG. 2 is a schematic illustration of an abort request, according to certain embodiments.

FIG. 3 is a flowchart illustrating an abort request process, according to certain embodiments.

FIG. 4 is a timing diagram of processing an abort request, according to certain embodiments.

FIG. 5 is a schematic illustration of a PRP list described in the NVMe standard, according to certain embodiments.

FIG. 6 is a schematic illustration of two host memory buffers (HMBs) used for command draining, according to certain embodiments.

FIG. 7 is a flowchart illustrating advanced command retry (ACR), according to certain embodiments.

FIG. 8 is a schematic diagram illustrating a multi-tenancy system supporting Address Translation Service (ATS) functionality, according to certain embodiments.

FIG. 9 is a flowchart illustrating command draining in an ATS according to one embodiment.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments of the disclosure may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the disclosure” shall not be construed as a generalization of any inventive subject matter disclosed herein and shall not be considered to be an element or limitation of the appended claims except where explicitly recited in a claim(s).

A data storage device can abort a command in a storage system having address translation service (ATS). When an abort command is received after a read command has been queued for execution, the ATS cache (ATC) can be poisoned to aid in aborting the read command when the read command execution cannot be stopped. Poisoning the ATC involves finding an entry in the ATC corresponding to a virtual address for the read command. The entry includes both the virtual address and a corresponding physical address for the read command. The physical address is changed in order to poison the entry. The new physical address can be an illegal address. When the controller is notified that the address is illegal, the controller can simply ignore the notification and inform the host device that the abort command was successful.

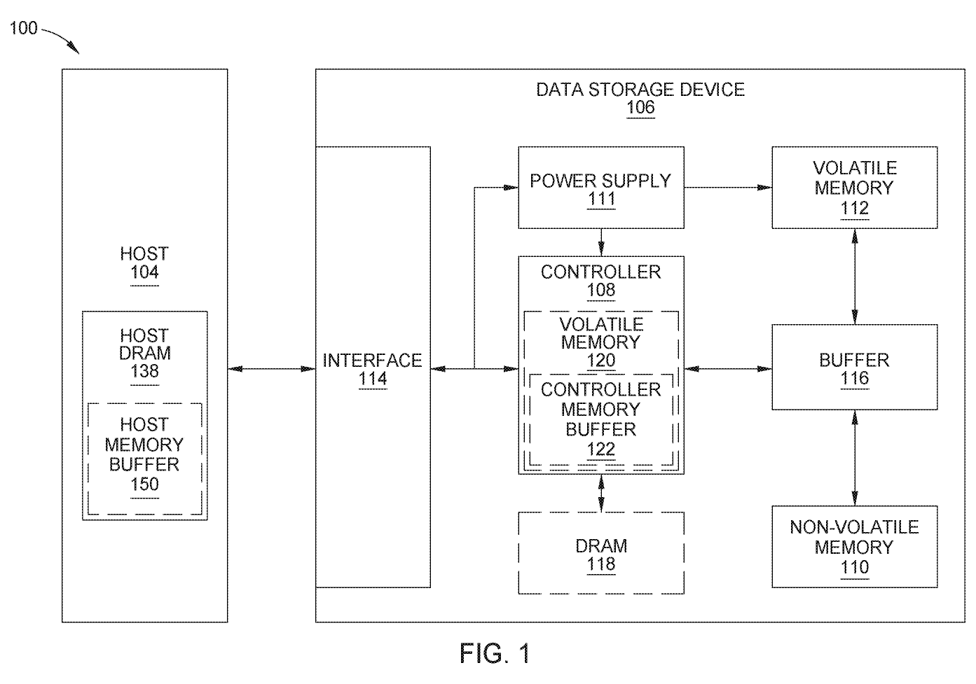

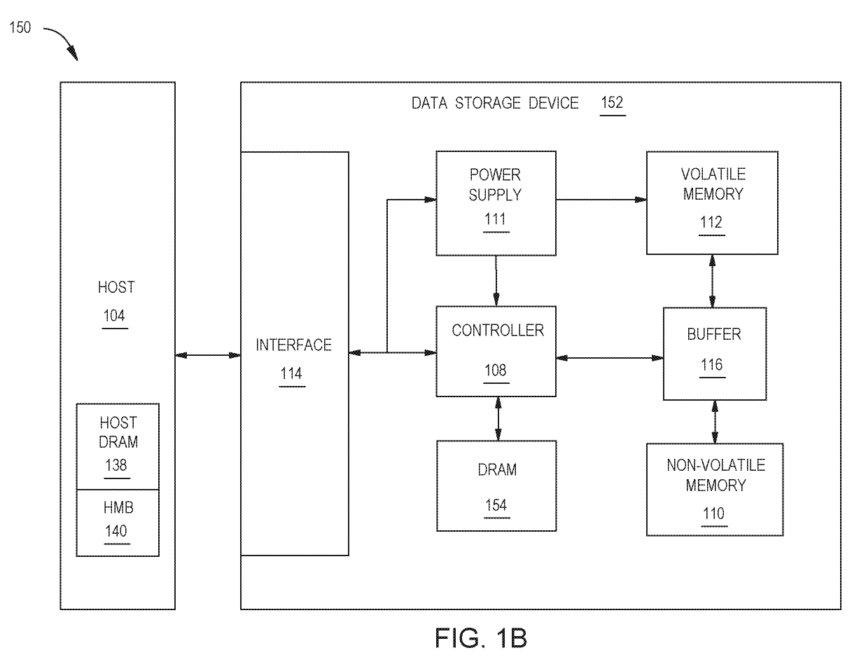

FIG. 1A is a schematic block diagram illustrating a storage system 100 in which data storage device 106 may function as a storage device for a host device 104, according to certain embodiments. For instance, the host device 104 may utilize a non-volatile memory (NVM) 110 included in data storage device 106 to store and retrieve data. The host device 104 comprises a host DRAM 138, where a portion of the host DRAM 138 is allocated as a host memory buffer (HMB) 140. The HMB 140 may be used by the data storage device 106 as an additional working area or an additional storage area by the data storage device 106. The HMB 140 may be inaccessible by the host device in some examples. In some examples, the storage system 100 may include a plurality of storage devices, such as the data storage device 106, which may operate as a storage array. For instance, the storage system 100 may include a plurality of data storage devices 106 configured as a redundant array of inexpensive/independent disks (RAID) that collectively function as a mass storage device for the host device 104.

The host device 104 may store and/or retrieve data to and/or from one or more storage devices, such as the data storage device 106. As illustrated in FIG. 1A, the host device 104 may communicate with the data storage device 106 via an interface 114. The host device 104 may comprise any of a wide range of devices, including computer servers, network attached storage (NAS) units, desktop computers, notebook (i.e., laptop) computers, tablet computers, set-top boxes, telephone handsets such as so-called “smart” phones, so-called “smart” pads, televisions, cameras, display devices, digital media players, video gaming consoles, video streaming device, or other devices capable of sending or receiving data from a data storage device.

The data storage device 106 includes a controller 108, NVM 110, a power supply 111, volatile memory 112, an interface 114, and a write buffer 116. In some examples, the data storage device 106 may include additional components not shown in FIG. 1A for the sake of clarity. For example, the data storage device 106 may include a printed circuit board (PCB) to which components of the data storage device 106 are mechanically attached and which includes electrically conductive traces that electrically interconnect components of the data storage device 106, or the like. In some examples, the physical dimensions and connector configurations of the data storage device 106 may conform to one or more standard form factors. Some example standard form factors include, but are not limited to, 3.5” data storage device (e.g., an HDD or SSD), 2.5” data storage device, 1.8” data storage device, peripheral component interconnect (PCI), PCI-extended (PCI-X), PCI Express (PCIe) (e.g., PCIe x1, x4, x8, x16, PCIe Mini Card, MiniPCI, etc.). In some examples, the data storage device 106 may be directly coupled (e.g., directly soldered) to a motherboard of the host device 104.

The interface 114 of the data storage device 106 may include one or both of a data bus for exchanging data with the host device 104 and a control bus for exchanging commands with the host device 104. The interface 114 may operate in accordance with any suitable protocol. For example, the interface 114 may operate in accordance with one or more of the following protocols: advanced technology attachment (ATA) (e.g., serial-ATA (SATA) and parallel-ATA (PATA)), Fibre Channel Protocol (FCP), small computer system interface (SCSI), serially attached SCSI (SAS), PCI, and PCIe, non-volatile memory express (NVMe), OpenCAPI, GenZ, Cache Coherent Interface Accelerator (CCIX), Open Channel SSD (OCSSD), or the like. The electrical connection of the interface 114 (e.g., the data bus, the control bus, or both) is electrically connected to the controller 108, providing electrical connection between the host device 104 and the controller 108, allowing data to be exchanged between the host device 104 and the controller 108. In some examples, the electrical connection of the interface 114 may also permit the data storage device 106 to receive power from the host device 104. For example, as illustrated in FIG. 1A, the power supply 111 may receive power from the host device 104 via the interface 114.

The NVM 110 may include a plurality of memory devices or memory units. NVM 110 may be configured to store and/or retrieve data. For instance, a memory unit of NVM 110 may receive data and a message from the controller 108 that instructs the memory unit to store the data. Similarly, the memory unit of NVM 110 may receive a message from the controller 108 that instructs the memory unit to retrieve data. In some examples, each of the memory units may be referred to as a die. In some examples, a single physical chip may include a plurality of dies (i.e., a plurality of memory units). In some examples, each memory unit may be configured to store relatively large amounts of data (e.g., 128MB, 256MB, 512MB, 1GB, 2GB, 4GB, 8GB, 16GB, 32GB, 64GB, 128GB, 256GB, 512GB, 1TB, etc.).

In some examples, each memory unit of NVM 110 may include any type of non-volatile memory devices, such as flash memory devices, phase-change memory (PCM) devices, resistive random-access memory (ReRAM) devices, magnetoresistive random-access memory (MRAM) devices, ferroelectric random-access memory (F-RAM), holographic memory devices, and any other type of non-volatile memory devices.

The NVM 110 may comprise a plurality of flash memory devices or memory units. NVM Flash memory devices may include NAND or NOR based flash memory devices and may store data based on a charge contained in a floating gate of a transistor for each flash memory cell. In NVM flash memory devices, the flash memory device may be divided into a plurality of dies, where each die of the plurality of dies includes a plurality of blocks, which may be further divided into a plurality of pages. Each block of the plurality of blocks within a particular memory device may include a plurality of NVM cells. Rows of NVM cells may be electrically connected using a word line to define a page of a plurality of pages. Respective cells in each of the plurality of pages may be electrically connected to respective bit lines. Furthermore, NVM flash memory devices may be 2D or 3D devices and may be single level cell (SLC), multi-level cell (MLC), triple level cell (TLC), or quad level cell (QLC). The controller 108 may write data to and read data from NVM flash memory devices at the page level and erase data from NVM flash memory devices at the block level.

The data storage device 106 includes a power supply 111, which may provide power to one or more components of the data storage device 106. When operating in a standard mode, the power supply 111 may provide power to one or more components using power provided by an external device, such as the host device 104. For instance, the power supply 111 may provide power to the one or more components using power received from the host device 104 via the interface 114. In some examples, the power supply 111 may include one or more power storage components configured to provide power to the one or more components when operating in a shutdown mode, such as where power ceases to be received from the external device. In this way, the power supply 111 may function as an onboard backup power source. Some examples of the one or more power storage components include, but are not limited to, capacitors, supercapacitors, batteries, and the like. In some examples, the amount of power that may be stored by the one or more power storage components may be a function of the cost and/or the size (e.g., area/volume) of the one or more power storage components. In other words, as the amount of power stored by the one or more power storage components increases, the cost and/or the size of the one or more power storage components also increases.

The data storage device 106 also includes volatile memory 112, which may be used by controller 108 to store information. Volatile memory 112 may include one or more volatile memory devices. In some examples, the controller 108 may use volatile memory 112 as a cache. For instance, the controller 108 may store cached information in volatile memory 112 until cached information is written to non-volatile memory 110. As illustrated in FIG. 1A, volatile memory 112 may consume power received from the power supply 111. Examples of volatile memory 112 include, but are not limited to, random-access memory (RAM) static RAM (SRAM), flip-flops, and latches.

The data storage device 106 includes a controller 108, which may include the volatile memory 112. For example, the controller 108 may include SRAM. Furthermore, the controller 108 may manage one or more operations of the data storage device 106. For instance, the controller 108 may manage the reading of data from and/or the writing of data to the NVM 110. In some embodiments, when the data storage device 106 receives a write command from the host device 104, the controller 108 may initiate a data storage command to store data to the NVM 110 and monitor the progress of the data storage command. The controller 108 may determine at least one operational characteristic of the storage system 100 and store the at least one operational characteristic to the NVM 110. In some embodiments, when the data storage device 106 receives a write command from the host device 104, the controller 108 temporarily stores the data associated with the write command in the internal memory or write buffer 116 before sending the data to the NVM 110. In some other embodiments, the HMB 140 may be utilized.

FIG. 1B is a schematic block diagram illustrating a storage system 150 in which data storage device 106 may function as a storage device for a host device 104, according to certain embodiments. For simplification purposes, common elements between the storage system 100 of FIG. 1A and the storage system 150 may be referenced by the same reference numeral. The storage system 150 is similar to the storage system shown in FIG. 1A. However, in the storage system 150, the data storage device 152 includes dynamic RAM (DRAM) 154, whereas in the storage system 100, the data storage device 106 is DRAM-less. In embodiments described herein, where the DRAM 154 is present, such as in the storage system 150, data and pointers corresponding to one or more commands may be temporarily stored in the DRAM 154 prior to being processed. However, in embodiments described herein, where the DRAM 154 is not present, such as in the storage system 100 where the data storage device 106 is DRAM-less, data and pointers corresponding to one or more commands may be temporarily stored in the HMB 140 or in other volatile memory, such as SRAM. Furthermore, examples of volatile memory 112 may further include, but not limited to, DRAM and synchronous dynamic RAM (SDRAM (e.g., DDR1, DDR2, DDR3, DDR3L, LPDDR3, DDR4, LPDDR4, and the like)).

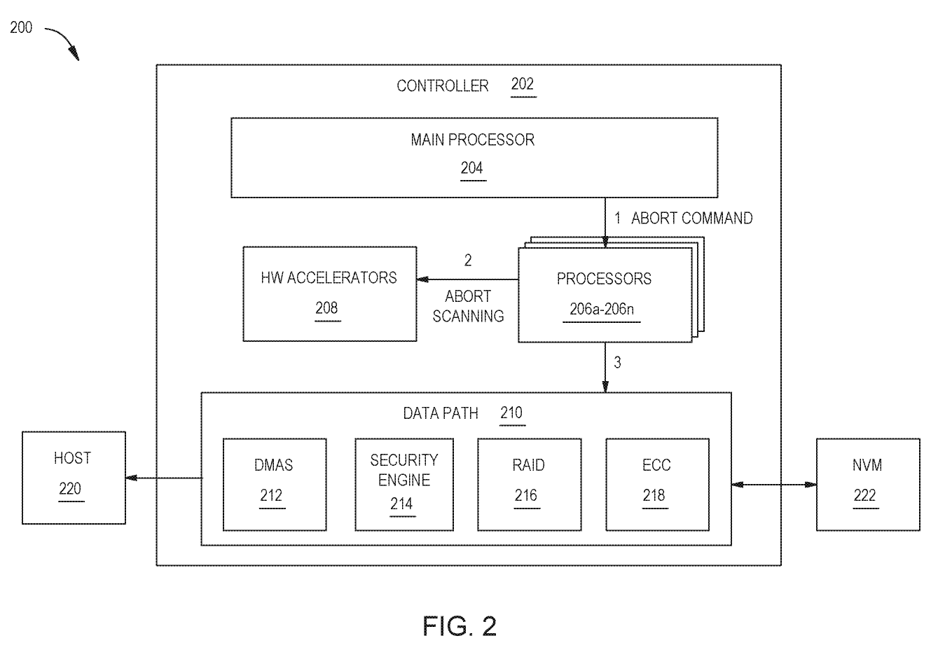

FIG. 2 is a schematic illustration of an abort request, according to certain embodiments. Aspects of FIG. 2 may be similar to the storage system 100 of FIG. 1A. For example, host 220 may be the host device 104, controller 202 may be the controller 108, and NVM 222 may be the NVM 110. During data storage device, such as the data storage device 106 of FIG. 1A operation, a pending command, such as host generated read command or a host generated write command, may be aborted by either the host 220 or by the controller 202. An abort command may be issued by the host 220 or by the controller 202. For example, the abort command may be generated by a main processor 204 of the controller 202, where the main processor 204 sends the abort command to one or more processors 206a-206n of the controller 202.

When abort command is received by the one or more processors 206a-206n, the one or more processors may either terminate all tasks associated with the abort command by scanning the pending commands or wait to terminate all pending commands not yet started, where the pending commands that are started are allowed to complete prior to terminating all other pending commands. After terminating the relevant pending commands, a completion message is issued to the host 220.

Regarding FIG. 2, the main processor 204 issues an abort command request to the one or more processors 206a-206n. The one or more processors 206a-206n utilizes the hardware (HW) accelerators 208 to scan each pending command and terminate the relevant pending commands. After terminating the relevant pending commands, the one or more processors 206a-206n posts a completion message, which may be a failure completion message if the abort command initiated by the data storage device, to the data path 210, where the data path 210 transmits the completion message to the host 220.

In regular operation, the data path 210 may be utilized to transfer data to and from the NVM 222 by utilizing the direct memory access (DMA) modules 212, encode/decode error correction code (ECC) using an ECC engine 218, generate security protocols by the security engine 214, and manage the storage of the data by the RAID module 216. The abort command operation may have a high latency before posting the completion message or the failure completion message to the host 220. Because of the high latency, buffer and the resources of the data storage device may be utilized inefficiently. Furthermore, certain cases of abort command operations may have to be performed separately or have a separate procedure to complete the certain cases of abort command operations.

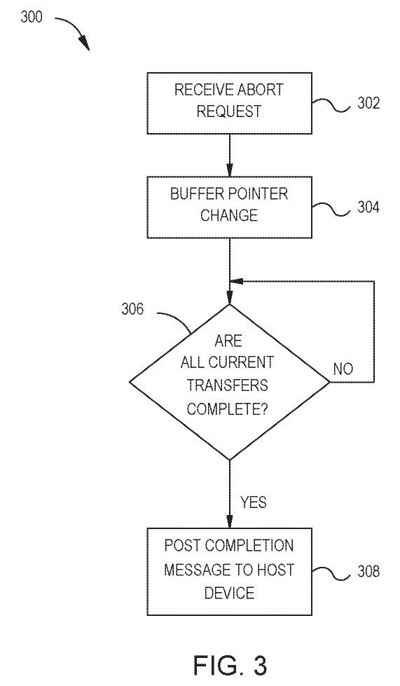

FIG. 3 is a flowchart illustrating an abort request process 300, according to certain embodiments. At block 302, an abort request or an abort command is received by the one or more processors, such as the one or more processors 206a-206n of FIG. 2, where the one or more processors may be a component of the controller, such as the controller 202 of FIG. 2. In some embodiments, the abort request may be generated by the host, such as the host 220, and transferred to the controller via a data bus. In other embodiments, the abort request may be generated by the main processor, such as the main processor 204 of FIG. 2, where the main processor sends the abort request to the relevant processor of the one or more processors.

At block 304, the controller modifies the content of the buffer pointers that reside in an internal copy of the command. In embodiments where the data storage device includes a DRAM, such as the data storage device 152 including the DRAM 154 of FIG. 1B, the internal copy of the command may be the command stored in the DRAM 154 of the data storage device 152. However, in embodiments where the data storage device is DRAM-less, such as the data storage device 106 of FIG. 1A, the internal copy of the command may be stored in an HMB, such as the HMB 140 of FIG. 1A, or in an internal cache, such as the SRAM of the controller 108. The buffer pointers may be pointing to the HMB, such as the HMB 140 of FIG. 1A. In some embodiments, the HMB includes two 4 KB HMB buffers. The previously listed values are not intended to be limiting, but to provide an example of a possible embodiment. At block 306, the controller determines if all the current transfers are complete. The current transfers may be commands executed, but not yet completed. If the current transfers are not yet complete, then the controller waits for the current transfers to be completed. However, if the current transfers are completed at block 306, then at block 308, the controller posts a completion message or a failure completion message to the host device.

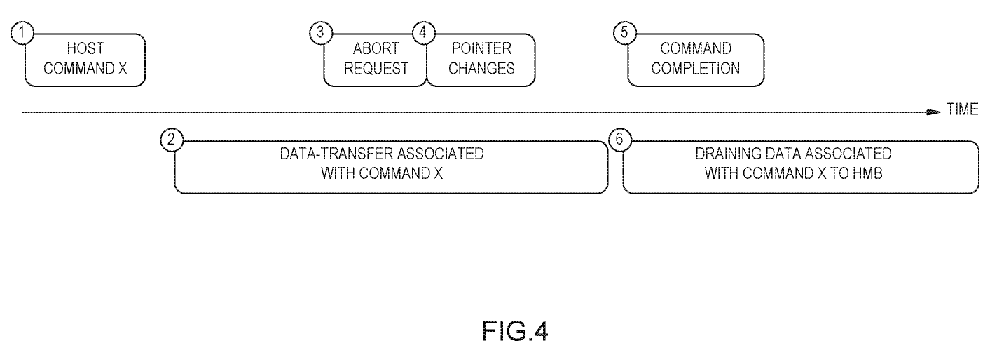

FIG. 4 is a timing diagram of processing an abort request, according to certain embodiments. Aspects of FIG. 4 may be similar to those described in FIG. 3. At time 1, the host device, such as the host device 104 of FIG. 1A, issues a command to the data storage device, such as the data storage device 106 of FIG. 1A. The command may either be a read command, a write command, or the like. At some time after the host issues the command to the data storage device, due to transfer latencies and the like, such as time 2, the controller, such as the controller 202 of FIG. 2, initiates the data transfer operation.

While the data transfer operation is executed, the data storage device receives an abort command at time 3. In one embodiment, the abort command may be generated by the host device. In another embodiment, the abort command may be generated by the data storage device, where the abort command is generated by the controller or the main processor, such as the main processor 204 of FIG. 2. At time 4, the data storage device modifies the one or more pointers associated with the abort command that resides in the data storage device. In embodiments where the data storage device includes a DRAM, such as the data storage device 152 of FIG. 1B, the one or more pointers may be stored in the DRAM 154 and the controller 108 may modify the one or more pointers associated with the abort command stored in the DRAM 154. However, in embodiments where the data storage device does not include the DRAM 154, such as the data storage device 106 of FIG. 1A, the one or more pointers may be temporarily stored in SRAM or stored in HMB and modified in either SRAM or the HMB.

At time 5, the data storage device sends a failure completion message to the host device, which occurs after the data transfer operation at time 2. At time 6, the data transfer operation has stopped and the data storage device drains a set of data associated with the abort request command to the HMB, such as the HMB 140 of FIG. 1A. In some embodiments, the draining of the set of data begins prior to posting the failure completion message to the host. In other embodiments, the failure completion message is posted before the data transfer to HMB operation is aborted. In embodiments where the data storage device includes a DRAM, such as the data storage device 152 of FIG. 1B, the set of data may be drained to the DRAM, such as the DRAM 154 of FIG. 1B.

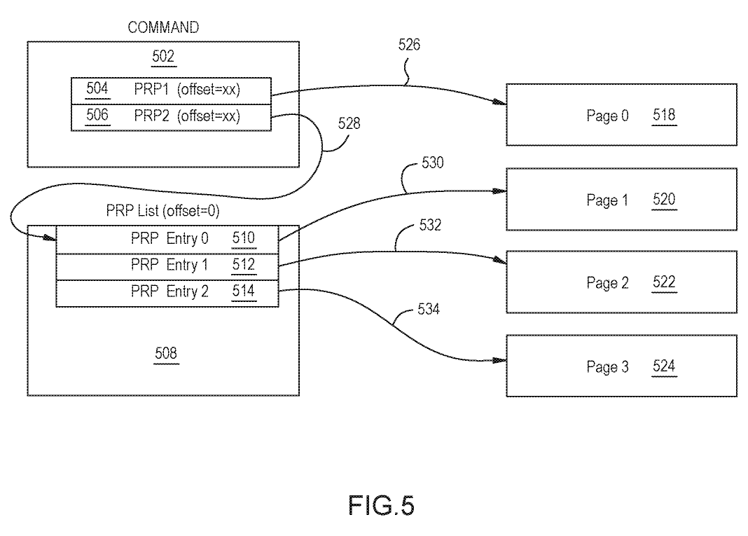

FIG. 5 is a schematic illustration of a PRP list described in the NVMe standard, according to certain embodiments. The command 502 includes a plurality of physical region page (PRP) pointers, such as a first PRP1 504 and a second PRP2 506, where each PRP pointer points to a buffer of a plurality of buffers. The plurality of buffers may be a portion of the HMB, such as the HMB 140 of FIG. 1A. Furthermore, in FIG. 5, each page, page 0 518, page 1 520, page 2 522, and page 3 524 represents a different buffer. In one example, each of the buffers may have a size of aligned to the size of a command or a dummy command, such as about 4 K. A dummy command may be a data storage device generated command to set parameters of the size of the buffers in the HMB. The first PRP1 504 and the second PRP2 506 includes an offset of “xx”, where the offset is a pointer offset from a location, such as a header. Each PRP pointer may either be a pointer pointing to a buffer or a pointer pointing to a list of entries.

For example, the first PRP1 504 includes a first pointer 526 that points to the first page 0 518. The second PRP2 506 includes a second pointer 528 that points to the first entry, PRP entry 0 510, of the PRP list 508. The PRP list 508 has an offset of 0, such that the PRP list 508 is aligned with the size of the buffer. For example, a first PRP entry 0 510 includes a third pointer 530 pointing to a second page 1 520, a second PRP entry 1 512 includes a fourth pointer 532 pointing to a third page 2 522, and a third PRP entry 2 514 includes a fifth pointer 534 pointing to a fourth page 3 524. The last entry of the PRP list 508 may include a pointer pointing to a subsequent or a new PRP list.

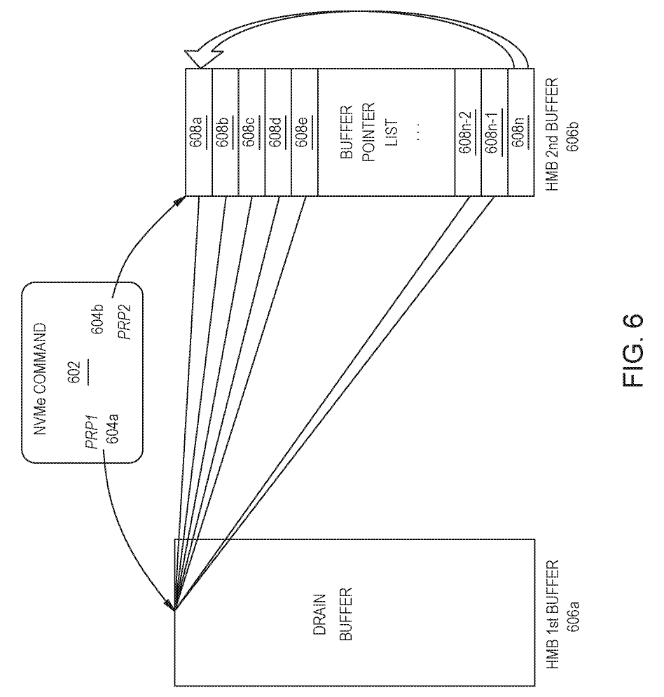

FIG. 6 is a schematic illustration of two host memory buffers (HMBs) used for command draining, according to certain embodiments. The NVMe command 602 is a stored copy of the commands received by the controller, where the NVMe command 602 may be stored in a volatile memory or a non-volatile memory of the data storage device. A first PRP1 604a may be the first PRP 504 and a second PRP2 604b may be the second PRP 506 of FIG. 5. The value of the first PRP1 604a is overwritten to point to a first HMB buffer 606a. The second PRP2 604b points to a second HMB buffer 606b.

The HMB, such as the HMB 140, includes the first HMB buffer 606a and the second HMB buffer 606b. The first HMB buffer 606a and the second HMB buffer 606b may have a size of about 4 KB. The first HMB buffer 606a may be utilized as a drain buffer, where the data associated with the abort command will be drained to or transferred to in both read operations and write operations. The second HMB buffer 606b is a list of a plurality of buffers 608a-608n.

The second HMB buffer 606b may be initialized by the controller, such as the controller 202 of FIG. 2, of the data storage device, such as the data storage device 106 of FIG. 1A, at the initialization phase. The initialization phase may be during the wake up operations of the data storage device, such as when power is supplied to the data storage device. Each pointer of the plurality of buffers 608a-608n of the second HMB buffer 606b points to the first HMB buffer 606a. Furthermore, rather than the last buffer 608n pointing to a subsequent or the next buffer list, the last buffer 608n points to the first buffer 608a of the same HMB buffer. By pointing each pointer of the second HMB buffer 606b to the first HMB buffer 606a, the pointer of the last buffer 608n of the second HMB buffer 606b to the first buffer 608a, and the pointer of the first PRP1 to the first HMB buffer 606a, the relevant data associated with the read operations or the write operations will be drained to the first HMB buffer 606a when an abort command is received.

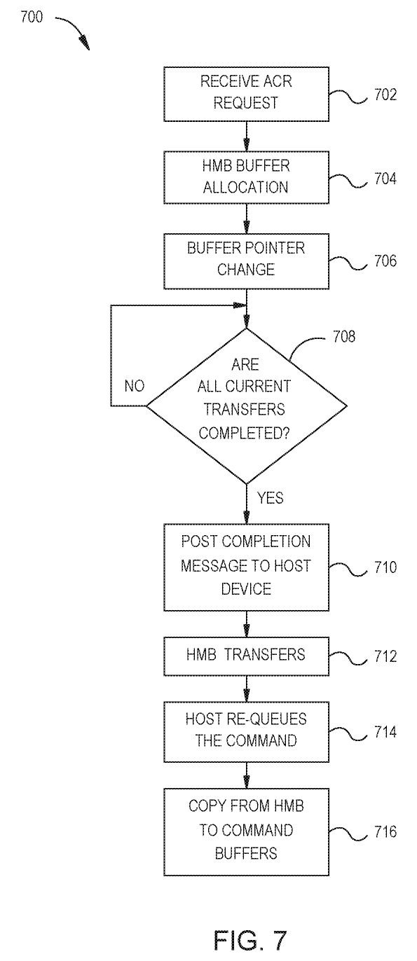

FIG. 7 is a flowchart 700 illustrating advanced command retry (ACR), according to certain embodiments. When the data storage device receives a command that includes an ACR request, one or more HMBs may be allocated to hold the set of data of the command. When a failed command has the ACR, the host, such as the host device 104 of FIG. 1A, is notified of the failed command and the host may re-queue the failed command in the command buffer after a delay, such as about 10 seconds. The delay times may be published by the data storage device, such as the data storage device 104 of FIG. 1A, via an identify controller command.

Rather than re-queueing the data associated with the failed command in the host buffer, such as the host DRAM 138 of FIG. 1A, outside of the host HMB, such as the HMB 140 of FIG. 1A, the data associated with the failed command is queued by the data storage device in the HMB. The flowchart 700 is initiated at block 702 when the ACR request for a command is received. At block 704, the HMB buffers are allocated. The HMB buffers includes a first HMB buffer, such as the first HMB buffer 606a of FIG. 6, and a second HMB buffer, such as the second HMB buffer 606b of FIG. 6, where the first HMB buffer is the drain buffer and the second HMB buffer is a list of buffer pointers pointing to the first HMB buffer.

At block 706, the internal versions of the pointers (i.e., PRP1 and PRP2) are modified to point to the allocated HMB buffers. For example, the PRP1 pointer may point to the first HMB buffer, and the PRP2 pointer may point to the second HMB buffer. At block 708, the controller determines if all the current transfers for commands that are already started with an associated target host buffer are completed. If the current transfers are not yet completed, then the controller waits for the commands to be completed.

At block 710, after all the current commands are completed, the controller posts a failure completion message to the host with the ACR indication for a command that has failed. At block 712, the one or more HMBs are accessed, such that the data of the failed command is transferred to a location of the one or more HMBs. A representation of the series of transfers is issued on the interface of the host device, where the series of transfers are stored in the one or more HMBs. When the HMB buffers are accessed, the data associated with the failed command is transferred to the first HMB buffer (i.e., the drain HMB buffer). At block 714, the host device re-queues the command to the data storage device, where the re-queued command is the original command that failed. At block 716, the data associated with the re-queued command is copied from the relevant location in the HMB, or in some embodiments, the one or more HMBs, to a host buffer. The re-queued command is executed by the controller utilizing the data stored in the host buffer.

Address Translation Cache (ATC) is a feature in PCIe where the data storage device receives untranslated addresses from a host device and before using those addresses, the addresses need to be translated by a translation agent (TA). The TA has a table of translated addresses and corresponding untranslated addresses. The host device sends, for example, a command to the endpoint (i.e., data storage device), and in the command there is an untranslated address. Before using the address, the endpoint first needs to obtain the translated address. The endpoint interacts with the TA to obtain the translated address. Upon receipt of the translated address from the TA, the endpoint will be able to use the translated address and store the translated address in the ATC.

In order to increase the performance and reduce the overhead over the link, the data storage device will negotiate with the TA in order to obtain the translated address. Before starting the negotiation with the TA, the end point first checks to see if the translated address is in the ATC. If the translated address is in the ATC, the endpoint will use the translated address stored in the ATC. Otherwise, the endpoint will start the interaction with the TA. In a multi-host or multi-tenancy device, such as when there are multiple functions, multiple physical functions, multiple virtual functions, or multiple hosts in the system, the system uses only a single ATC for all hosts or functions such that all hosts or functions have access to the same ATC.

For a global ATC, all functions will be able to use the ATC with no special policy. For example, data will be evicted from the ATC based upon least recently used (LRU) or some other criteria. However, there is no space reserved for any specific function in global ATC. Another approach is the static ATC attribute where at the beginning, the ATC is allocated for the functions/hosts, such as when a function needs a higher QoS compared to other functions. For the function that needs a higher QoS, perhaps half of the ATC can be allocated to the function and the remainder allocated to the remaining functions so that one function will be able to provide better performance compared to the other functions. With the static ATC attribute, the ATC distribution does not change.

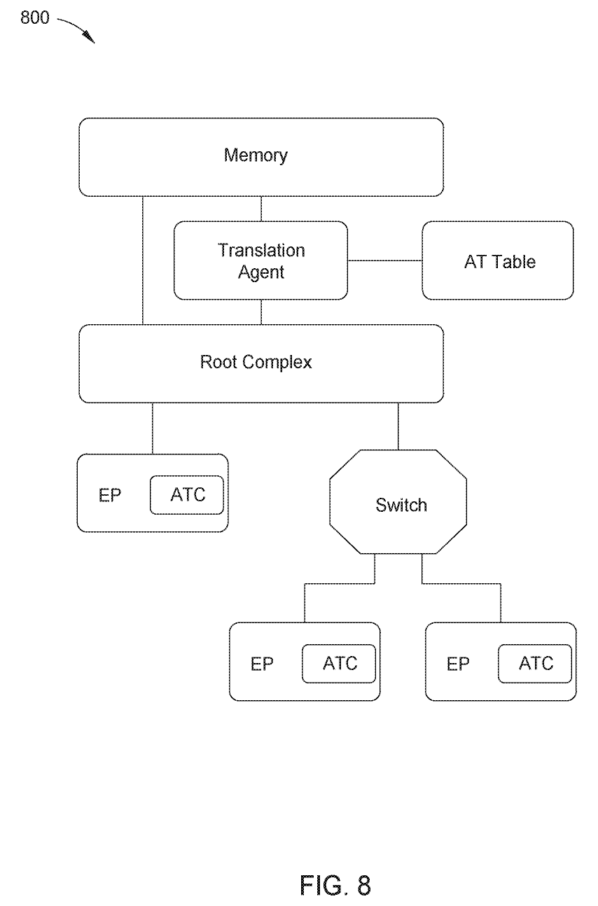

FIG. 8 is a schematic diagram illustrating a multi-tenancy system 200 supporting Address Translation Service (ATS) functionality, according to certain embodiments. A TA services memory translation requests. The ATC is referred to as a translation look-aside buffer (TLB) in the TA. When the ATS enabled SSD device accesses system memory, the SSD shall cache translated addresses in an internal ATC. The ATC is different from the TLB translation cache used by the host device. The ATS enabled SSD device shall implement and maintain a designated ATC to minimize performance dependencies on the TA and alleviate TA resource pressure.

Examples of PCIe addresses to be translated include: caching of submission queue (SQ) and completion queue (CQ) address ranges; SQ entry decoding including standard decoding of the data pointer for read or write that submit translation requests immediately, PRPs and SGLs that decode the data pointers and follow linked lists and upper bound of translations per large commands equal a rate match PRI translations with Gen5 bandwidth (BW) maximums, and DIX translation requests for metadata pointers and associated linked lists of addresses.

The ATC serves as a global resource shared among multiple clients, including PCIe functions and applications. The performance and QoS of the memory device rely on the chosen attributes of the shared resource. There is a significant advantage in employing an algorithm capable of detecting the optimal ATC attributes that yield the best performance results.

In regard to draining and ATS, for draining purposes, the resolved address can be changed when an abort or a forced abort is received in a very high IOPS device that supports ATS. More specifically, drain mode is about using a memory buffer that is irrelevant in order to be able to safely divert and abort an abort command that is already too far into processing to be able to abort. ATS can be leveraged for the situation. In PCIe, there is the host side address translation to go from a virtual address to a physical address. When doing so, there is a problem with draining because the controller may be draining to the wrong address, which has to be translated. Ultimately, the controller is not going to overwrite memory when draining, but the controller can leverage ATS by poisoning the ATC in order to make sure that the drain is to null.

At a high queue depth, poisoning the ATC is done because the controller does not want the drain to be to a real location. In PCIe, an illegal address is allowed. When an illegal address is used, there may be a notification of the illegal address, but for draining purposes, the notification can be ignored and there will be no damage so long as the controller knows that the address used is an illegal address. When the ATC is poisoned, then the controller knows that the address is illegal because the controller did the poisoning.

Hence, taking a step back, the idea behind the change to the resolved address is to either poison the resolved address or send the resolved address to a known good that is an address that doesn’t matter. Poisoning the address just in the ATC and not as a real address is the easier option. It is important to note to not actually turn the poisoned address into a real poisoned address. The goal is to make sure that the address drained to is not going to hurt anything. In other words, don’t have the poisoned address ending up in memory where the controller is allowed to write, but did not intend to write to.

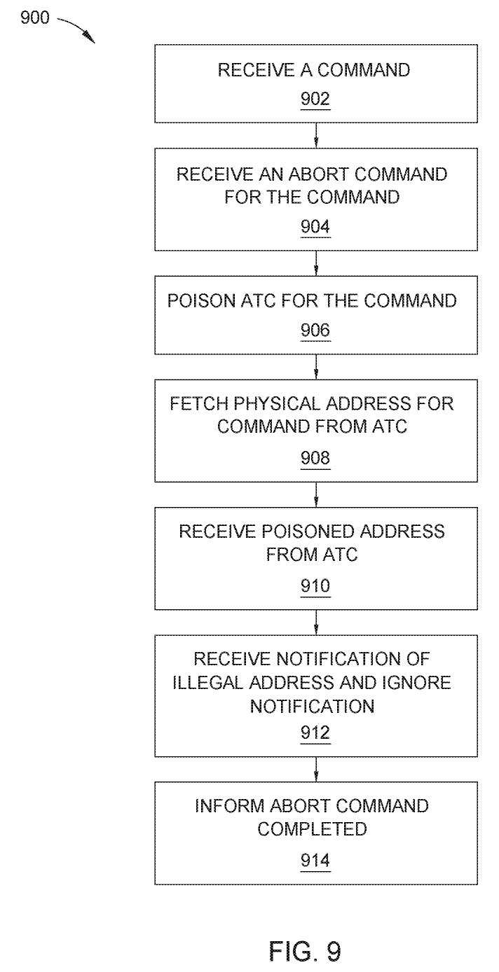

FIG. 9 is a flowchart illustrating command draining in an ATS according to one embodiment. Initially, a command is received by the controller of the data storage device at block 902. At some point later after the command has been received, but before the command is completed, an abort command is received for the command at block 904.

Upon receiving the abort command, the controller will proceed to poison the ATC for the command at block 906. By poisoning the ATC, the controller will simply find the virtual address for the command in the ATC and then change the physical address in the ATC to be a different address. The different address in the ATC can be an illegal address in one embodiment because illegal addresses are permitted in PCIe. Alternatively, the different address in the ATC can be to a dedicated drain location such as a drain buffer as discussed above.

Regardless, after the poisoning, the controller will fetch the physical address for the command from the ATC at block 908, and the address fetched will be the poisoned address (i.e., the different address). At block 910, the controller will receive the poisoned address and begin to execute the command using the poisoned address. It will not be possible to complete execution of the command due to the poisoned address. Hence, the controller will receive a notification of the illegal address, which can be ignored at block 912. Finally, the controller will not notify of the command failure due to the illegal address, but instead will notify the host device of the successful completion of the abort command at block 914.

As an example, consider receiving a read command from a host device. The read command contains a virtual address to which a physical address is needed. The controller will then work with the TA to obtain the physical address from the address translation (AT) table. Once the physical address is obtained, then the read command can be executed, and the ATC can be updated to include the physical address for the virtual address in case there is ever another read command for the same virtual address. In that scenario, because the physical address is already in ATC, there is no need to engage the TA.

At a point later in time, a new read command may be received for the same virtual address. Before the ATC is searched for the new read command, an abort command for the new read command can be received. At this point in time, the controller can poison the ATC by changing the physical address in the ATC that corresponds to the virtual address for the new read command. The poisoned address can be an illegal address in one embodiment. Now, when the controller searches the ATC to see if there is an entry corresponding to the virtual address in the new read command, the controller will find the poisoned address and thus use the poisoned address for executing the new read command. Naturally, because the physical address is a poisoned address, the new read command will fail, and the controller will be notified of the failure. Because the new read command was aborted and not expected to be executed from the host device perspective, the controller will not inform the host device that the new read command failed. Instead, the controller will simply ignore the notification that the address was an illegal address and complete the abort command.

Now that the abort command is completed and the ATC has a poisoned physical address, there may be an issue if another read command is issued for the same virtual address. Hence, there are several options. The controller can, after receiving the notification and ignoring the notification, clear the entry from the ATC that corresponds to the virtual address. In other words, the controller can remove the poisoned address form the ATC so that a future read command for the same virtual address will need to involve negotiating with the TA for execution to obtain the physical address. Another option is for the controller to pre-emptively (i.e., without receiving a new read command for the virtual address) renegotiate with the TA to re-obtain the physical address and replace the poisoned address in the ATC with the correct physical address. Still another option is for the controller to maintain a table of physical addresses that were replaced with poisoned addresses, consult the table, and then replace the poisoned address in the ATC with the correct physical address without involving the TA. In any event, the controller will need to take some action to ensure that the poisoned address is not reused for the same virtual address.

By changing the content of ATC, abort commands can be processed much more efficiently leading to improved storage device performance. Aborting a command in a simple way while not having any latency compared to the complex, high latency flows that exist today improves efficiency.

In one embodiment, a data storage device comprises: one or more memory devices; and a controller coupled to the one or more memory devices, wherein the controller is configured to: receive a command from a host device, wherein the command has a virtual address, wherein the controller maintains an ATC, and wherein the ATC contains an entry for the virtual address; receive an abort command for the command; poison the ATC; execute the command; and inform the host device that the abort command completed. When the controller is configured to search the ATC for the virtual address and retrieve a physical address. Poisoning the ATC comprises replacing a valid physical address for the virtual address with a different address. The different address is an illegal address. The controller is configured to receive a notification that the different address is the illegal address. The controller is configured to ignore the notification. The controller is configured to delete the virtual address from the ATC. The controller is further configured to poison only the entry for the virtual address during the poisoning. The poisoning comprises changing a physical address for the virtual address to a different address. The different address corresponds to a drain location. The controller is configured to: allocate an HMB, wherein the HMB is a drain buffer.

In another embodiment, a data storage device comprises: one or more memory devices; and a controller coupled to the one or more memory devices, wherein the controller is configured to: poison an ATC in response to receiving an abort command; and inform a host device that the abort command completed. Poisoning the ATC comprises changing an entry of the ATC. After the poisoning, the ATC contains one or more valid entries and the poisoned entry. The controller is configured to erase the poisoned entry after the poisoned entry is read from the ATC. The erasing occurs after receiving a notification that the poisoned entry is an illegal physical address. The changed entry points to an HMB.

In another embodiment, a data storage device comprises: one or more memory means; and a controller coupled to the one or more memory means, wherein the controller is configured to: receive a command from a host device, wherein the command has a virtual address, wherein the controller maintains an ATC, and wherein the ATC contains an entry for the virtual address; receive an abort command for the command; change a physical address of the entry to an illegal address; receive a notification that the physical address is the illegal address; and erase the entry from the ATC. The command is failed and the host device is not notified of the failure. The host device is notified of the abort command completion.

While the foregoing is directed to embodiments of the present disclosure, other and further embodiments of the disclosure may be devised without departing from the basic scope thereof, and the scope thereof is determined by the claims that follow.

What is claimed is:

1. A data storage device, comprising:
one or more memory devices; and
a controller coupled to the one or more memory devices, wherein the controller is configured to:
receive a command from a host device, wherein the command has a virtual address, wherein the controller maintains an address translation cache (ATC), and wherein the ATC contains an entry for the virtual address;
receive an abort command for the command;
poison the ATC;
execute the command; and
inform the host device that the abort command completed.

2. The data storage device of claim 1, wherein when the controller is configured to search the ATC for the virtual address and retrieve a physical address.

3. The data storage device of claim 1, wherein poisoning the ATC comprises replacing a valid physical address for the virtual address with a different address.

4. The data storage device of claim 3, wherein the different address is an illegal address.

5. The data storage device of claim 4, wherein the controller is configured to receive a notification that the different address is the illegal address.

6. The data storage device of claim 5, wherein the controller is configured to ignore the notification.

7. The data storage device of claim 1, wherein the controller is configured to delete the virtual address from the ATC.

8. The data storage device of claim 1, wherein the controller is further configured to poison only the entry for the virtual address during the poisoning.

9. The data storage device of claim 1, wherein the poisoning comprises changing a physical address for the virtual address to a different address.

10. The data storage device of claim 9, wherein the different address corresponds to a drain location.

11. The data storage device of claim 10, wherein the controller is configured to: allocate a host memory buffer (HMB), wherein the HMB is a drain buffer.

12. A data storage device, comprising:
one or more memory devices; and
a controller coupled to the one or more memory devices, wherein the controller is configured to:
poison an address translation cache (ATC) in response to receiving an abort command; and
inform a host device that the abort command completed.

13. The data storage device of claim 12, wherein poisoning the ATC comprises changing an entry of the ATC.

14. The data storage device of claim 13, wherein after the poisoning, the ATC contains one or more valid entries and the poisoned entry.

15. The data storage device of claim 14, wherein the controller is configured to erase the poisoned entry after the poisoned entry is read from the ATC.

16. The data storage device of claim 15, wherein the erasing occurs after receiving a notification that the poisoned entry is an illegal physical address.

17. The data storage device of claim 13, wherein the changed entry points to a host memory buffer (HMB).

18. A data storage device, comprising:
one or more memory devices; and
a controller coupled to the one or more memory devices, wherein the controller is configured to:
receive a command from a host device, wherein the command has a virtual address, wherein the controller maintains an address translation cache (ATC), and wherein the ATC contains an entry for the virtual address;
receive an abort command for the command;
change a physical address of the entry to an illegal address;
receive a notification that the physical address is the illegal address; and
erase the entry from the ATC.

19. The data storage device of claim 18, wherein the command is failed, and the host device is not notified of the failure.

20. The data storage device of claim 19, wherein the host device is notified of the abort command completion.
